(19) United States
(12) Patent Application Publication
(10) Pub. No.: US 2015/0147106 A1
(43) Pub. Date: May 28, 2015

(54) WRITING INSTRUMENT

(71) Applicant: MICRO CO., LTD., Tokyo (JP)

(72) Inventor: Keito HASHIMOTO, Koriyama-shi (JP)

(21) Appl. No.: 14/528,176

(22) Filed: Oct. 30, 2014

(30) Foreign Application Priority Data
Nov. 25, 2013 (JP) 2013-242798

(51) Int. Cl. B43K 24/06; B43K 23/08

(52) U.S. Cl. CPC B43K 24/06; B43K 23/08
USPC 401/108

(57) ABSTRACT

A writing instrument has a cam rotatably connected to a rear end of a main body so that rotation of the cam in opposite directions within a predetermined range advances and retracts a refill housed in the main body. A sealing section seals the front end of the refill when it is fully retracted in the main body. The outer configurations of the main body and the working cam have a generally regular triangle shape in cross section, and the outer configurations are coincident with each other at the position where rotation of the working cam starts and are rotationally shifted relative to one another when the working cam is rotated, whereby the rotation state of the working cam can be discerned by the coincidence or non-coincidence of the outer configurations.

### FIELD OF THE INVENTION

The present invention relates generally to a writing instrument in which the front end of a refill is protruded from or retracted into the front end of a main body by rotation of a rotatable portion disposed at the rear end of the main body, and particularly a writing instrument in which a sealing section that seals the front end of the refill is disposed in the main body.

### BACKGROUND INFORMATION

There have been known writing instruments which have a refill containing a volatile or easily drying ink such as a marker and at its front end an open-and-close type sealing section. As a mechanism for feeding a refill housed in a main body, for example, a knocking-type writing instrument has been known in which the front end of a refill is fed via a rotatable cam which rotates (turns) back and forth by a knocking operation as described in JP-A-2004-167830. Further, another rotatable type writing instrument has been known in which the front end of a refill is fed by directly conducting a rotation operation of a rotatable member as described in JP-A-6-286390.

In the case of the knocking operation, the feeding operation of the refill can easily be made by pressing a knocking button, but if the knocking button is accidently depressed when placing the writing instrument in a bag or a garment pocket, the writing front end may accidently protrude from the main body and stain the surroundings. Further, with respect to the sealing section for sealing the front end of the refill, in the case of a knocking-type writing instrument, the sealing section is opened by advancing the rotatable cam by pushing the knocking button, and the front end of the refill is protruded from the main body. When the refill is retracted by a knocking operation, the knocking button returns to the original position and the sealing section is closed. Since movement of the knocking button does not stop in an intermediate position during a knocking operation, the position of the knocking button shows whether the refill is on forward movement or backward movement. Further, the position of the knocking button shows whether the sealing section is opened or closed.

On the other hand, in the case of a rotatable type writing instrument, rotation of the rotating member for advancing and retracting the refill can be stopped at any position during the course of rotation. Accordingly, by viewing the position of the rotating member, it is impossible to know the state of the writing front end of the refill in the forward and backward movements or the state of the sealing section in the opening and closing operations. For example, in the writing instrument described in JP-A-6-286390, the forward and backward movements of a cartridge are conducted by rotating the rotating member disposed at the rear end of an external member, and at the same time, a cap is opened and closed. With this writing instrument, since the external member and the rotating member both have the same cylindrical shape, when the rotating member is turned and stopped, it is unclear to what degree the rotating member has been rotated and it is impossible to see from viewing the exterior of the writing instrument the position of the cartridge during the forward and backward movements or the state of closing by the cap. If the rotation of the rotating member is stopped in a state when the writing front end of the cartridge is not completely housed, the sealing of the writing front end is insufficient and the writing front end tends to undergo drying, whereby it becomes useless at an early stage.

Further, with conventional rotatable type writing instruments, it is impossible for a user to determine the extent or degree of rotation of the rotating member or if the sealing section is opened or closed by tactile sensation, i.e., by the user touching the outer periphery of the writing instrument with his or her fingers.

### SUMMARY OF THE INVENTION

An object of the present invention is to provide a writing instrument having a sealing section that seals a refill in its retracted state and that overcomes the aforementioned drawbacks of the prior art.

Another object of the present invention is to provide a writing instrument having an extendable/retractable refill and in which the fully retracted state of the refill can be visually and tactilely discerned based on the coincidence of the outer configurations of relatively movable parts of the writing instrument.

Another object of the present invention to provide a writing instrument in which the front end of a refill such as a marker is fed from a main body by rotating a rotating member and a sealing section for sealing the front end of the refill is disposed in the main body, wherein the movement state of the front end of the refill and the opening and closing state of the sealing section can be readily determined by either visual inspection or tactile sensation.

The writing instrument according to one aspect of the present invention comprises a main body and a working cam which is connected at a rear portion of the main body to undergo rotation (turning) within a predetermined range. The working cam has a screw-like cam groove. A refill is removably inserted in a non-rotatable fashion in the main body. The refill has a guide pin which engages with the cam groove so that the refill advances or retracts in the axial direction when the working cam rotates. Inside the main body, a sealing section is disposed such that when the front end of the refill is housed in the main body, the sealing section seals the front end of the refill, and when the refill advances, the sealing section releases the sealing to allow the front end of the refill to protrude.

According to another aspect of the present invention, the writing instrument includes a regulating member that regulates the rotation of the working cam so that the working cam can rotate between one end position in which the refill is fully retracted and another end position in which the refill is fully advanced. The main body and the working cam are formed in a shape other than a circle so that when the working cam is located at the end position where the refill is fully retracted, the outer configurations of the main body and the working cam coincide with each other, and when the working cam rotates to the other end position, the outer configurations of the main body and the working cam are shifted relative to one another, whereby the rotation of the working cam can be easily discerned and readily known.

Preferably, the outer configurations of the main body and the working cam have a generally regular triangle shape in cross section. The rotation-regulating member of the working cam is constituted by a control rib disposed in the main body and a cutaway portion disposed at the working cam. The cutaway portion is designed so that when the working cam is located at one end position at which the rotation starts, one end of the cutaway portion abuts on the control rib, and when the working cam is rotated 180 degrees and located at the other end position at which the rotation ends, the other end of the cutaway portion abuts on the control rib.

In one example of the present invention, the main body and the working cam are formed in a shape other than a circle so that when the working cam is located at the position of the start of rotation, the outer configurations of the main body and the working cam coincide with each other, and when the working cam rotates (turns), the outer configurations of the main body and the working cam are shifted, whereby the rotation of the working cam can be easily known. In this example, in the initial state where the front end of the refill is housed in the main body, the outer configurations of the main body and the working cam coincide with each other and therefore it can easily be determined not only by visual inspection but also by tactile sensation by the user's fingers touching the outer configurations of the main body and the working cam that the front end of the refill is housed in the main body and securely sealed with the sealing section.

When the working cam is rotated (turned) through a predetermined range, the rotation of the working cam is stopped at a constant position by the regulating member, and the outer configurations of the main body and the working cam do not coincide with each other. At this moment, since the front end of the refill protrudes from the main body, it can be determined by visual inspection of the outer appearance of the main body and also by the user's fingers touching the outer configurations of the main body and the working cam that the front end of the refill is located at the protruded position.

Further, when the working cam is rotated (turned) in the reverse direction, the rotation stops when it rotates through a predetermined range and the outer configurations of the main body and the working cam coincide with each other. At this moment, since the sealing section is closed and the front end of the refill is sealed, the condition of sealing can be easily discerned. If the outer configurations of the main body and the working cam do not coincide with each other, further rotation is needed to rotate the working cam to the position where coincidence can be confirmed.

In another example, if the outer configurations of the main body and the working cam are formed in a generally regular triangle shape in cross section and the rotation range of the working cam is adjusted to be 180 degrees, when the front end of the refill is completely sealed with the sealing section, the outer configurations of the main body and the working cam coincide with each other in a generally regular triangle shape in cross section, and therefore confirmation can clearly be made by both visual inspection and tactile sensation. In this example, when the working cam is rotated 180 degrees through the predetermined range, the outer appearance of the outer configuration becomes a generally regular hexagonal shape in cross section, whereby this difference in shape (triangle vs. hexagonal) can be easily confirmed by visual inspection and tactile sensation. If the regulating member of the working cam is constituted by a regulating member disposed in the main body and a cutaway portion disposed at the working cam, when the working cam is located at the position at which the rotation starts, one end of the cutaway portion abuts on the control rib, and when the working cam is located at the position where it has rotated 180 degrees from the position at which the rotation starts and where the rotation ends, another end of the cutaway portion abuts on the control rib, whereby the structure of the regulating member is simple and the fabrication operation can be made easily.

Additional objects, advantages and aspects of the present invention will be set forth in part in the description which follows, and in part will become apparent to those skilled in the art upon reading the following description or may be learned by practice of the invention.

### BRIEF DESCRIPTION OF THE DRAWINGS

FIGS. 1A to 1D illustrate an example of a writing instrument embodying the present invention, wherein FIG. 1A is a cross-sectional view in a longitudinal direction, FIG. 1B is a cross-sectional view along the 1B-1B line of FIG. 1A, FIG. 1C is a cross-sectional view along the 1C-1C line of FIG. 1A, and FIG. 1D is a cross-sectional view along the 1D-1D line of FIG. 1A.

FIGS. 2A to 2G show a main body, wherein FIG. 2A is a plane view, FIG. 2B is a front view, FIG. 2C is a cross-sectional view along a rotation-preventing projection, FIG. 2D is a cross-sectional view along a receiver hole, FIG. 2E is a left-side elevational view, FIG. 2F is a right-side elevational view, and FIG. 2G is a cross-sectional view along the 2G-2G line of FIG. 2C.

FIGS. 3A to 3E show a tapered member, wherein FIG. 3A is a front view, FIG. 3B is a bottom view, FIG. 3C is a cross-sectional view, FIG. 3D is a left-side elevational view, and FIG. 3E is a right-side elevational view.

FIGS. 4A to 4E show a working cam, wherein FIG. 4A is a plane view, FIG. 4B is a front view, FIG. 4C is a cross-sectional view, FIG. 4D is a left-side elevational view, and FIG. 4E is a developed explanatory view of the cam face.

FIGS. 5A to 5D show a cap, wherein FIG. 5A is a plane view, FIG. 5B is a front view, FIG. 5C is a cross-sectional view, and FIG. 5D is a left-side elevational view.

FIGS. 6A to 6D show an internal cam, wherein FIG. 6A is a front view, FIG. 6B is a cross-sectional view, FIG. 6C is a right-side elevational view, and FIG. 6D is a developed explanatory view of the cam face.

FIG. 7 is a cross-sectional view showing the internal cam incorporated into the main body.

FIGS. 8A and 8B show the relation between the main body and the internal cam, wherein FIG. 8A is an explanatory view showing the front end of a refill housed in the main body, and FIG. 8B is an explanatory view showing the front end of the refill is protruded for writing.

FIGS. 9A to 9E show an ink reservoir, wherein FIG. 9A is a plane view, FIG. 9B is a cross-sectional view, FIG. 9C is a left-side elevational view, FIG. 9D is a cross-sectional view along the 9D-9D line of FIG. 9B, and FIG. 9E is a cross-sectional view along the 9E-9E line of FIG. 9B.

FIGS. 10A to 10F show a lead tube, wherein FIG. 10A is a plane view, FIG. 10B is a cross-sectional view, FIG. 10C is a left-side elevational view, FIG. 10D is a right-side elevational view, FIG. 10E is a cross-sectional view along the 10E-10E line of FIG. 10B, and FIG. 10F is a cross-sectional view along the 10E-10F line of FIG. 10B.

FIG. 11 is a front view of a tip.

FIGS. 12A to 12E show a holder, wherein FIG. 12A is a plane view, FIG. 12B is a front view, FIG. 12C is a cross-sectional view, FIG. 12D is a right-side elevational view, and FIG. 12E is a left-side elevational view.

FIGS. 13A to 13E show a cylindrical seal, wherein FIG. 13A is a plane view, FIG. 13B is a front view, FIG. 13C is a bottom view, FIG. 13D is a cross-sectional view, and FIG. 13E is a left-side elevational view.

FIG. 14 is an explanatory view showing the relation between the main body and the working cam in the state shown in FIG. 1.

FIG. 15 is an explanatory view showing the working cam slightly rotated from the FIG. 1A position.

FIG. 16 is an explanatory view showing the state when the working cam is further rotated from the state shown in FIG. 15 and a lid of a sealing section is opened.

FIG. 17 is an explanatory view showing the writing instrument in a writing state where the front end of the refill protrudes from the main body.

FIG. 18 is an explanatory view showing the relation of the main body and the working cam in the writing state.

FIGS. 19A to 19C show another example of a writing instrument embodying the present invention, wherein FIG. 19A is a plane view in a state where the front end of a refill is retracted in a main body, FIG. 19B is a front view, and FIG. 19C is an explanatory view of a state where the front end of the refill protrudes from a main body.

### DETAILED DESCRIPTION OF THE PREFERRED EMBODIMENTS

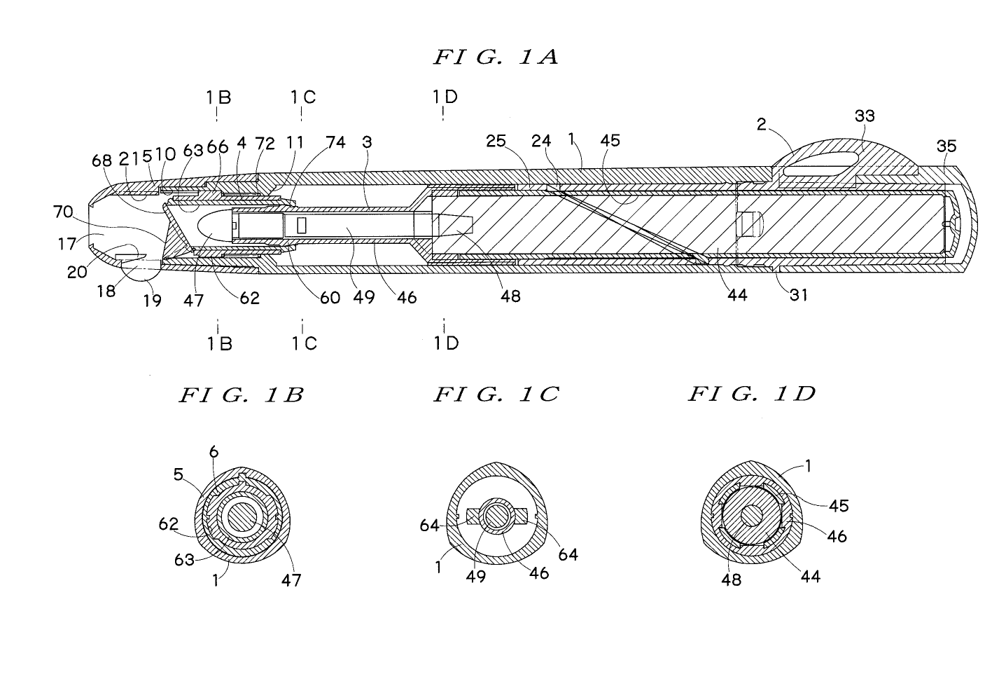

FIGS. 1A to 1D show one example of a writing instrument embodying the present invention. The writing instrument in this example has a cylindrical main body 1, a working cam 2 rotatably (turnably) connected at the rear end of the main body 1, a refill 3 which advances or retracts in the axial direction of the main body 1 by rotation (turning) of the working cam 2, and a sealing section 4 that seals the front end portion of the refill. In this example, the main body 1 is formed in a generally regular triangle shape in cross section.

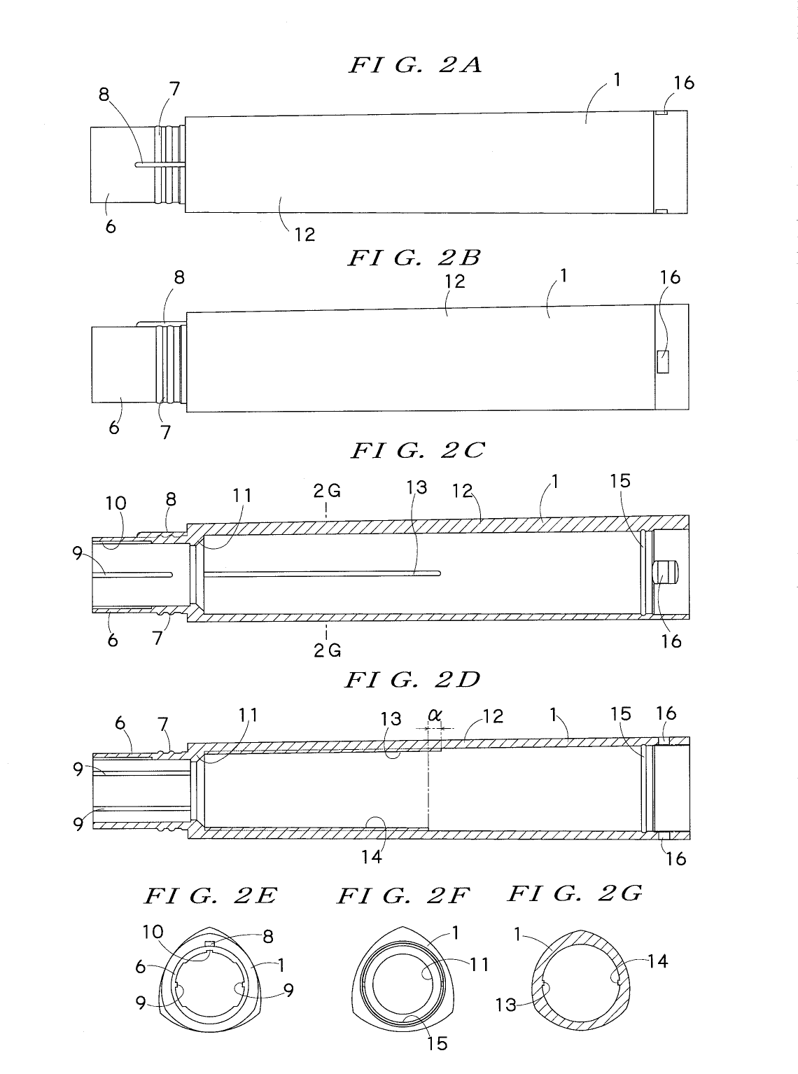

Referring to FIGS. 2A-2G, the main body 1 has at its front portion, a small diameter portion 6 on which is inserted a tapered member 5. At the outer face of the small diameter portion 6, an annular locking projection 7 and a rotation-preventing projection 8 which extends in the axial direction are provided. At the inner face of the small diameter portion 6, as shown in FIGS. 2C-2E, two opposed rotation-preventing ribs 9 which extend in the axial direction, and an axially extending long groove 10 are formed. At a large diameter portion 12 of the main body 1, the outer diameter and the inner diameter expand wider than that of the small diameter portion 6 via a stepped portion 11, and at its inner face, as shown in FIGS. 2C, 2D and 2G, a control rib 13 which extends in the axial direction, and a stop rib 14 which also extends in the axial direction are formed facing each other. As shown in FIG. 2D, the internal rear end of the control rib 13 extends rearward beyond the internal rear end of the stop rib 14 by a length a. Further, at the inner face of the rear part of the main body 1, an annular projection 15 and a receiver hole 16 are formed to rotatably mount the working cam 2 while preventing axial movement thereof relative to the main body.

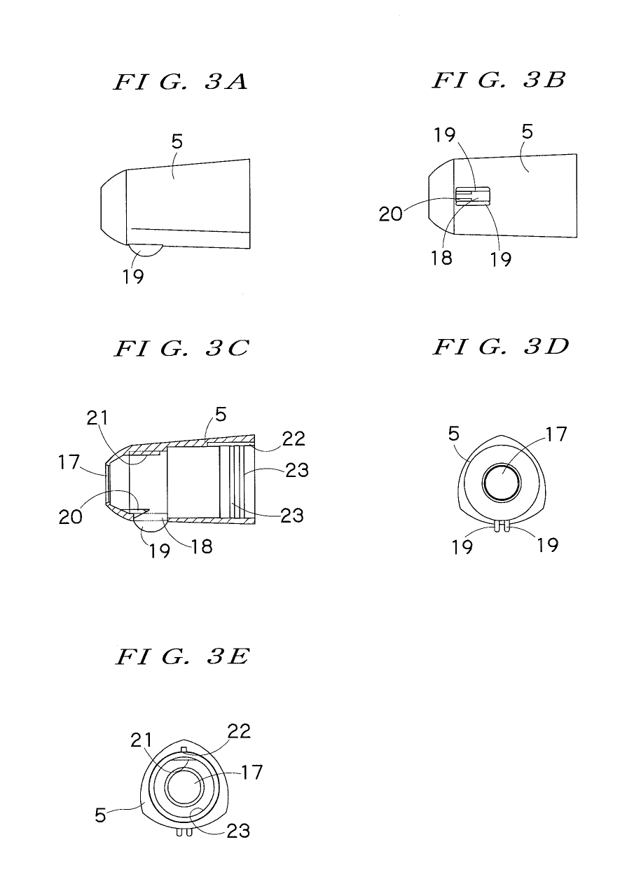

The tapered member 5 is, as shown in FIGS. 3A-3C, a tapering cylindrical body having a front opening 17 through which the front end of the refill 3 protrudes and retracts, and the tapered member 5 has the same configuration as the outer shape of the main body 1 and is formed in a generally regular triangle shape in cross-section in this example. At one side of the tapered member 5, an escape hole 18 is formed, and at the outer portion of the escape hole 18, on opposite sides thereof, two opposed ribs 19 are formed. As shown in FIGS. 3B and 3C at the inner face of the tapered member 5, a pawl piece 20 is formed and extends rearward along the side edge of the escape hole 18. At the inner face of the tapered member which faces the escape hole 18, a plane portion 21 is formed (see FIGS. 3C and 3E). Further, the tapered member 5 has an axially extending receiver groove 22 through which the rotation-preventing projection 8 formed at the small diameter portion 6 of the main body 1 is inserted, and an annular locking projection 23 which engages with the locking projection 7 of the small diameter portion.

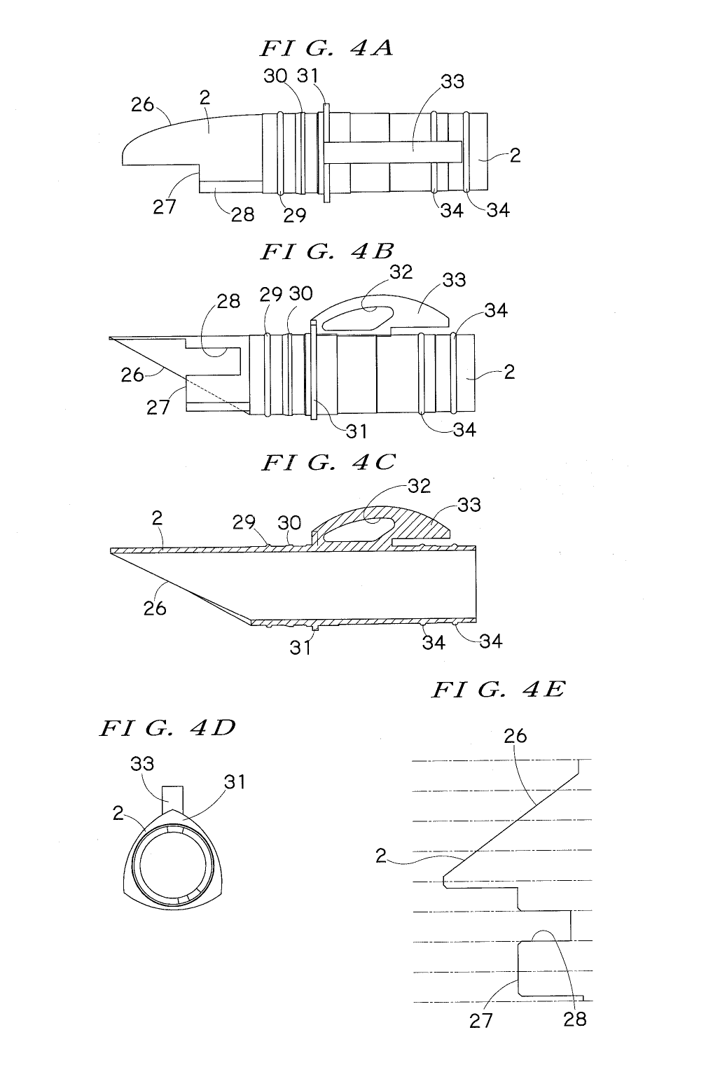

The working cam 2 has a screw-shaped (spiral or helical shape) cam groove 24. In the examples, the cam groove 24 is formed by combining a rear end of an internal cam 25 with the front end of the working cam 2, i.e., the cam groove 24 is formed partly by the working cam 2 and partly by the internal cam 25. The working cam 2 is, as shown in FIGS. 4A-4D, formed in a cylindrical shape so that it can be rotatably (turnably) inserted into the main body 1, and at its intermediate part, has a flange 31 formed in a generally regular triangle shape in cross section to fit to the outer shape of the main body 1. At the forward part of the working cam 2 are formed a slanting face 26 that together with a slanting face 38 of the internal cam 25 form the cam groove 24, an abutment face 27 that abuts on the internal cam 25, and a recess 28 to mesh with the internal cam. FIG. 4E is a two-dimensional development view of the cam face of the working cam 2. At the outer periphery of the working cam 2, are formed an annular engaging projection 29 which rotatably engages with the annular projection 15 of the main body 1, an annular projection 30 which engages with the receiver hole 16 of the main body 1, and the flange 31 which abuts on the rear end of the main body 1. At the rear portion of the flange 31, a knob piece 33 having a hole 32, and annular locking projections 34 are disposed. In this example, the cam groove 24 is formed in such a length that within a 180° range of rotation (turning) of the working cam 2, the writing front end of the refill 3 can be advanced to the protruded position and retracted from the writing position to the housed position.

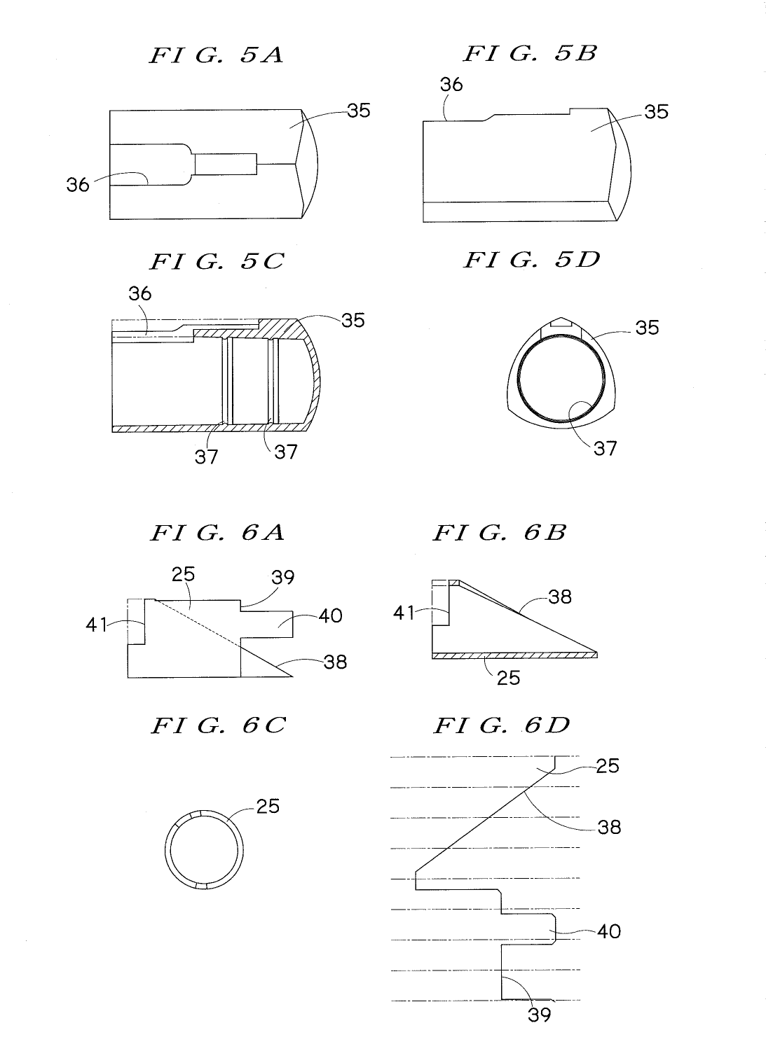

To the rear end of the working cam 2, a cap 35 is attached. The cap 35 is, as shown in FIGS. 5A-5D, formed in a cylindrical shape of which the rear end is closed, and has an outer configuration of a generally regular triangle shape in cross section. At the outer periphery, are formed a recess 36 to receive the knob piece 33 of the working cam 2, and locking projections 37 which engage with the locking projections 34 of the working cam 2. When the cap 35 is attached to the working cam 2, the front end of the cap abuts on the flange 31 of the working cam, and the outer configuration of the cap 35 has a generally regular triangle shape in cross section, namely, has the same appearance as the outer configuration of the main body 1.

The internal cam 25 has an outer diameter that allows the cam to be rotatably (turnably) inserted into the main body 1 as shown in FIGS. 6A-6C. At the side face of the rear portion of the internal cam 25 that faces the working cam 2, the slanting face 38 is formed, and the slanting face 38 together with the opposedly facing slanting face 26 of the working cam 2 form therebetween the cam groove 24. Further, an abutment face 39 which abuts on the abutment face 27 of the working cam 2 and a joint projection 40 which engages with the recess 28 of the working cam are provided. FIG. 6D is a two-dimensional development view of the cam face of the internal cam 25. The width of the cam groove 24 is regulated by the abutment of the abutment faces 27, 39. With this structure, the internal cam 25 and the working cam 2 are integrally combined to form a cam structure having the cam groove 24. Thus, the working cam 2 and the internal cam 25 are preassembled, and it is possible to integrate the working cam 2 and the internal cam 25 prior to insertion in the main body 1.

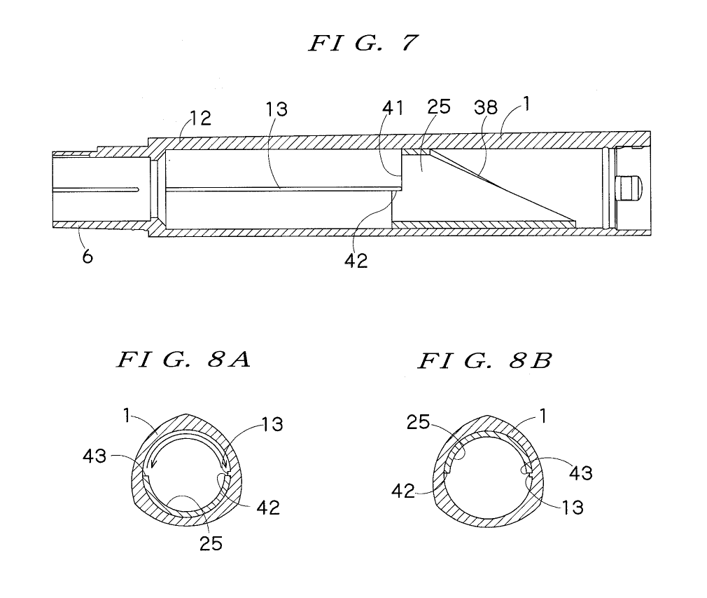

The working cam 2 is provided with a regulating member to regulate the rotation of the working cam so that the working cam can rotate between the start position of rotation where the refill is retracted rearward into the main body 1 and the end position of rotation where the refill is advanced forward and the front end of the refill protrudes from the main body. In the example shown in the figures, the regulating member comprises a cutaway portion 41 formed at the internal end side of the internal cam 25, and as shown in FIGS. 8A and 8B, one end 42 of the cutaway portion 41 and another end 43 thereof are circumferentially spaced apart and positioned facing each other by 180 degrees. Further, as shown in FIG. 7, the rear end of the control rib 13 disposed within the main body 1 is designed to enter the cutaway portion 41. By this structure, the working cam 2 can rotate from the position where the one end 42 of the cutaway portion 41 abuts on the control rib 13 (FIG. 8A) to the position where the other end 43 of the cutaway portion 41 abuts on the control rib 13 (FIG. 8B). The depth of the cutaway portion 41 is designed taking into account the length a so that when the internal cam 24 is inserted to the position where its internal end abuts on the stop rib 14 of the main body 1, the rear end of the control rib 13 can enter the cutaway portion 41.

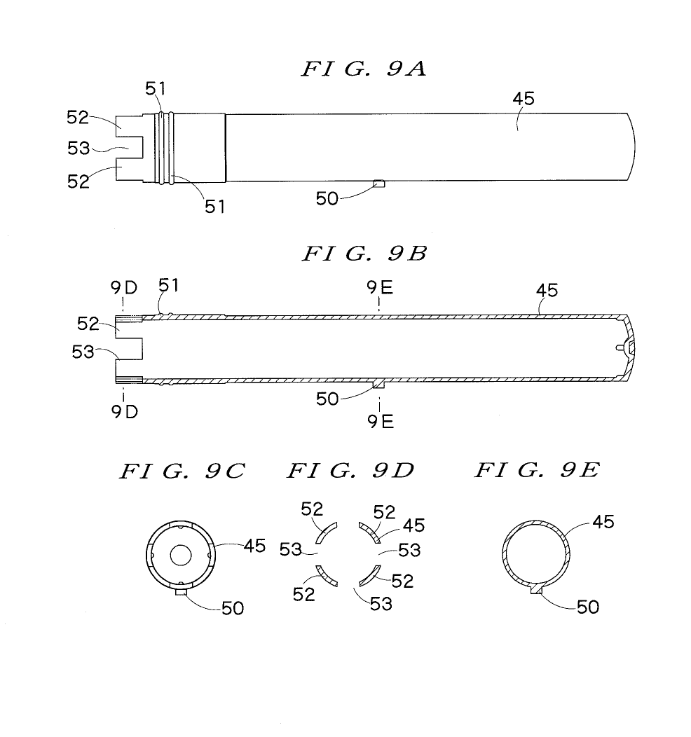

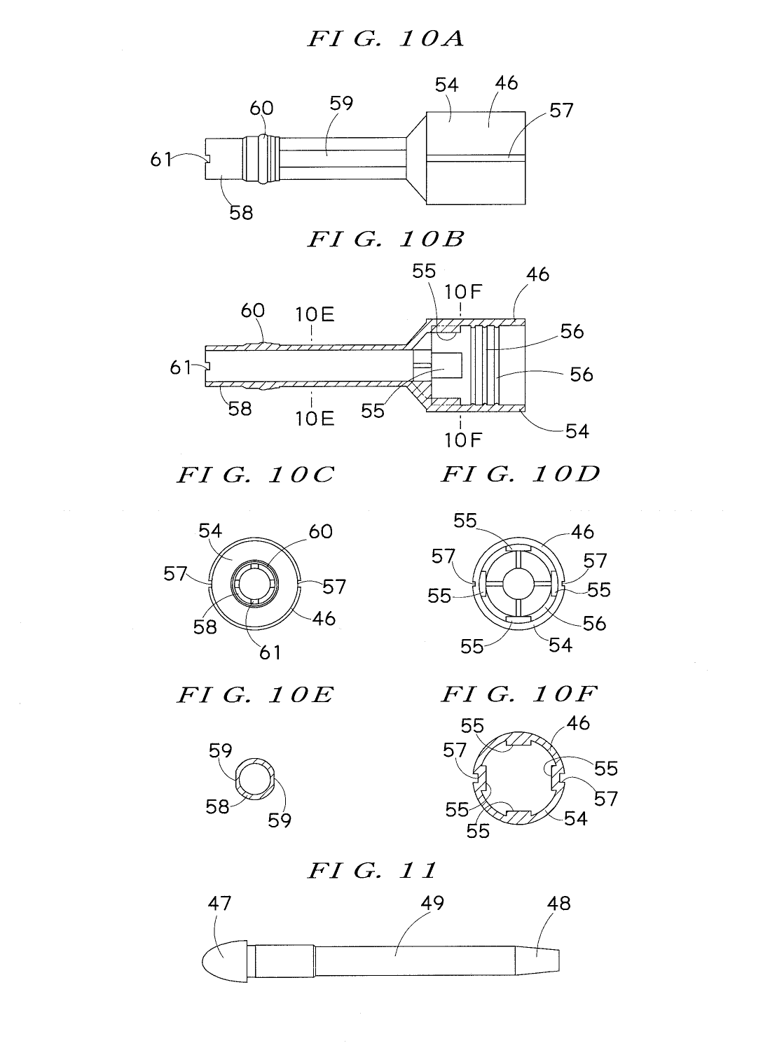

The refill 3 is constituted by an ink reservoir 45 (FIGS. 9A-9E) that contains a rod-like padding 44 (see FIG. 1A) for storing ink, a lead tube 46 (FIGS. 10A-10F) which is connected to the ink reservoir 45, and a tip 49 (FIG. 11). The tip 49 has a writing front end 47 at its front end and an insertion end 48 which is inserted into the padding 44 at its rear end, and the tip 49 is inserted into the lead tube 46. As shown in FIGS. 9A-9C and 9E, the ink reservoir 45 has at its outer periphery a guide pin 50 which engages with the cam groove 24 of the cam structure comprised of the working cam 2 and the internal cam 25. At the front end of the ink reservoir 45, annular locking projections 51, locking pawls 52 which extend forward, and a locking groove 53 are disposed.

As shown in FIGS. 10A-10F, at the rear end of the lead tube 46, a large diameter portion 54 is formed through which the front end of the ink reservoir 45 is inserted. At the inner face of the large diameter portion 54, are disposed opposed internal projections 55 which are fitted into the locking pawls 52 and the locking groove 53 of the ink reservoir 45 in a mutually complementary fashion, and locking projections 56 which engage with the annular locking projections 51. At the outer face of the large diameter portion of the lead tube 46, a sliding groove 57 extending in the axial direction is formed. By this arrangement, the lead tube 46 can move in the axial direction without rotating by slidable engagement of the sliding groove 57 with the control rib 13 and the stop rib 14 of the main body 1. Further, at a small diameter portion 58 at the forward portion of the lead tube 46, opposed plane portions 59 and an annular sealing projection portion 60 are formed, and at the front end, a small recess 61 is formed.

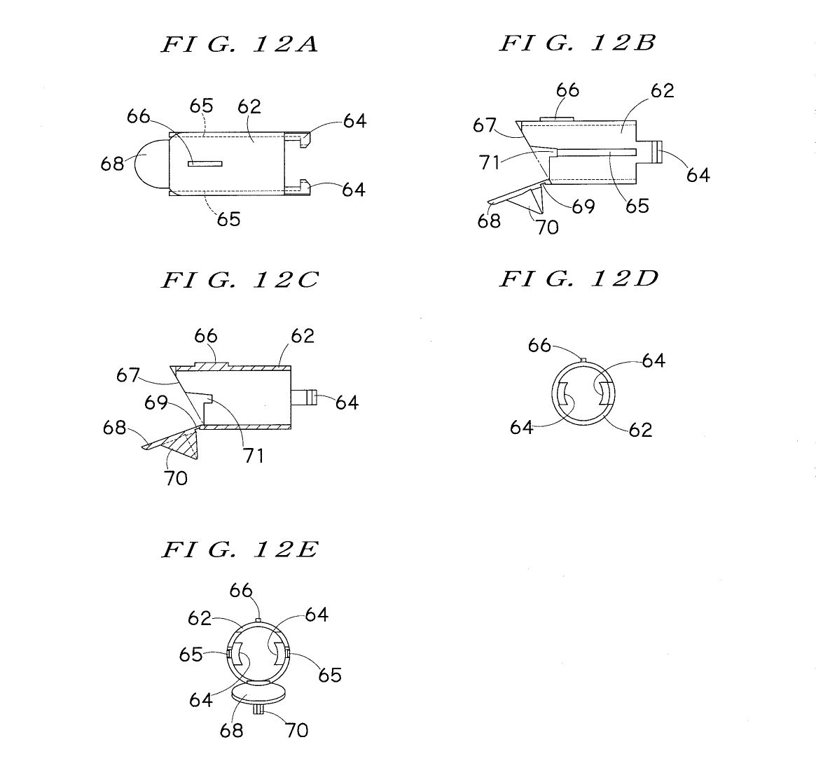

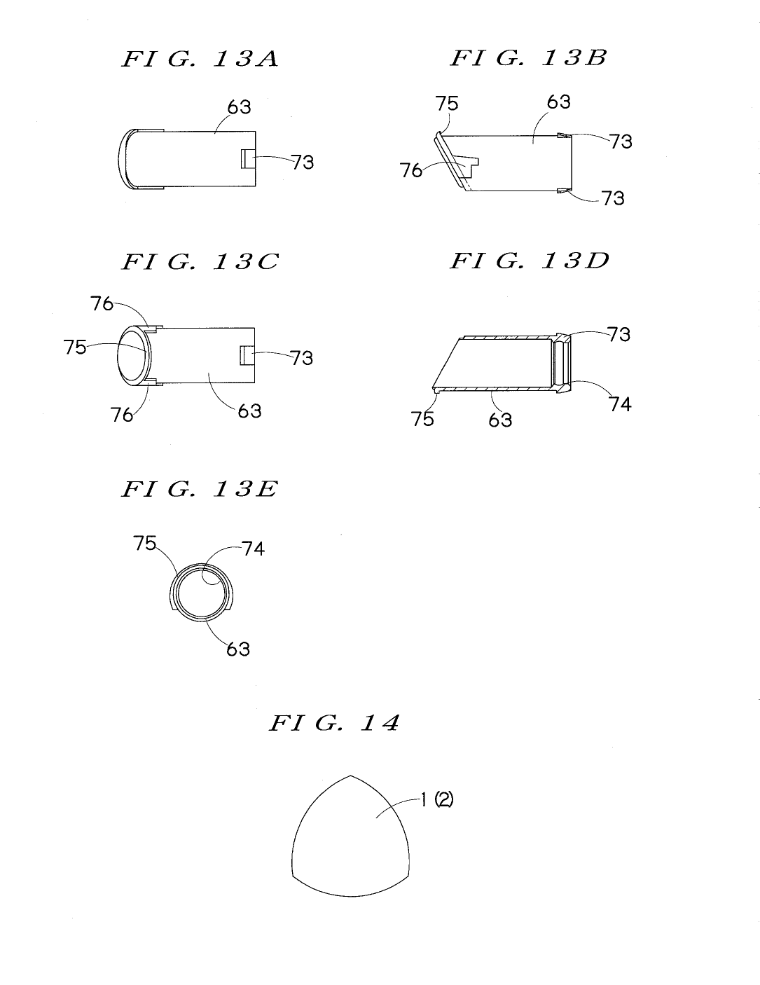

When the writing front end 47 is housed in the main body 1, the sealing section 4 seals the writing front end 47 of the refill 3, and when the refill 3 advances, the sealing section 4 releases the sealing and allows the writing front end 47 to project. The sealing section 4 can be formed in various constitutions. By way of example, in the embodiment shown in FIG. 1, the sealing section 4 is constituted by a holder 62 (FIGS. 12A-12E) made of, preferably, a hard plastic material, etc., and a cylindrical seal 63 (FIGS. 13A-13E) which is housed in the holder 62 and made of, preferably, a flexible plastic material, etc.

As shown in FIGS. 12A-12E, the holder 62 is formed to have an outer diameter that can be slidably inserted into the small diameter portion 6 of the main body 1, and at its rear end, has opposed elastic pawls 64 which slidably move on the opposed plane faces 59 at the outer face of the lead tube 46. When the refill 3 retracts, the elastic pawls 64 engage with the side face of the sealing projection portion 60 and function so that the holder 62 retracts together with the lead tube 46. At the side face of the holder 62, are disposed opposed receiver grooves 65 which slidably engage with the rotation-preventing ribs 9 disposed at the inner face of the small diameter portion 6 of the main body 1, and a guide projection 66 which slidably engages with the long groove 10 of the main body 1. The front portion of the holder 62 has a slanting face 67 and a pivotable lid 68 which is capable of opening and closing via a hinge 69. At the back face of the lid 68, a pressing rib 70 having a stepped portion formed on its side face is disposed. At a part of the slanting face 67, a recess 71 is formed. The holder 62 is slidably inserted into the small diameter portion 6 of the main body 1, and urged forward by a spring 72 disposed between the stepped portion 11 of the main body 1 and the guide projection 66 (see FIG. 1A). The spring 72 can be omitted without impairing the sealing function of the sealing section 4.

The cylindrical seal 63 has openings at the front and rear parts and is inserted into the holder 62. At the rear portion of the cylindrical seal 63, a locking projection 73 is formed for locking with the rear end of the holder 62. At the inner face of the cylindrical seal 63, is disposed an inner sealing projection 74 which abuts on the sealing projection portion 60 of the lead tube 46 and seals the outer periphery of the lead tube 46 when the refill 3 is housed in the main body 1. Further, at the front end of the cylindrical seal 63, are disposed a projection 75 which engages with the peripheral edge of the slanting face 67 of the holder 62, and a projection 76 which engages with the recess 71 of the slanting face 67. By this structure, the cylindrical seal 63 is attached to the holder 62 under such condition that the cylindrical seal cannot be rotated.

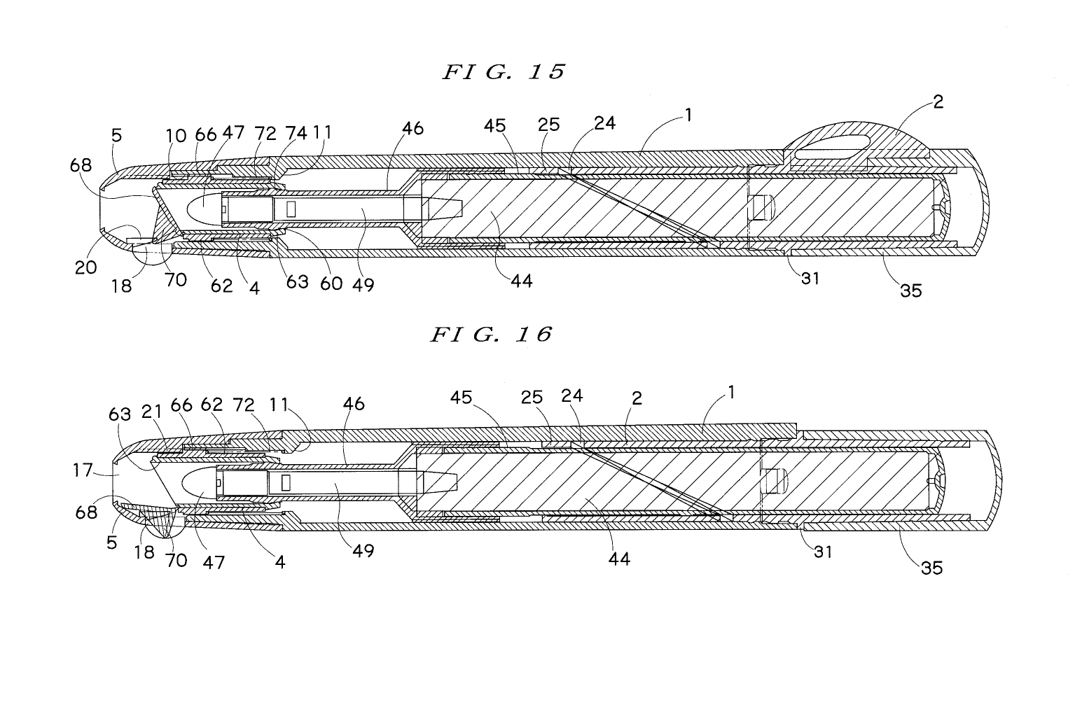

In the above structure, as shown in FIG. 1A, in such state that the refill 3 retracts and the writing front end 47 is housed in the main body 1, the front opening of the cylindrical seal 63 is closed by the lid 68, and the sealing projection portion 60 of the lead tube 46 abuts on the inner sealing projection 74, whereby the rear opening of the cylindrical seal 63 is closed as well. Under such circumstances, the writing front end 47 is sealed by the sealing section 4 to prevent it from drying. In this state, the outer configuration of the main body 1 coincides with that of the working cam 2 at the abutting portion of the flange 31, and this state of coincidence is schematically illustrated in FIG. 14 which shows that the outer profiles of the main body 1 and the working cam 2 coincide with one another. Further, the guide pin 50 of the refill is positioned at the rear end side of the cam groove 24.

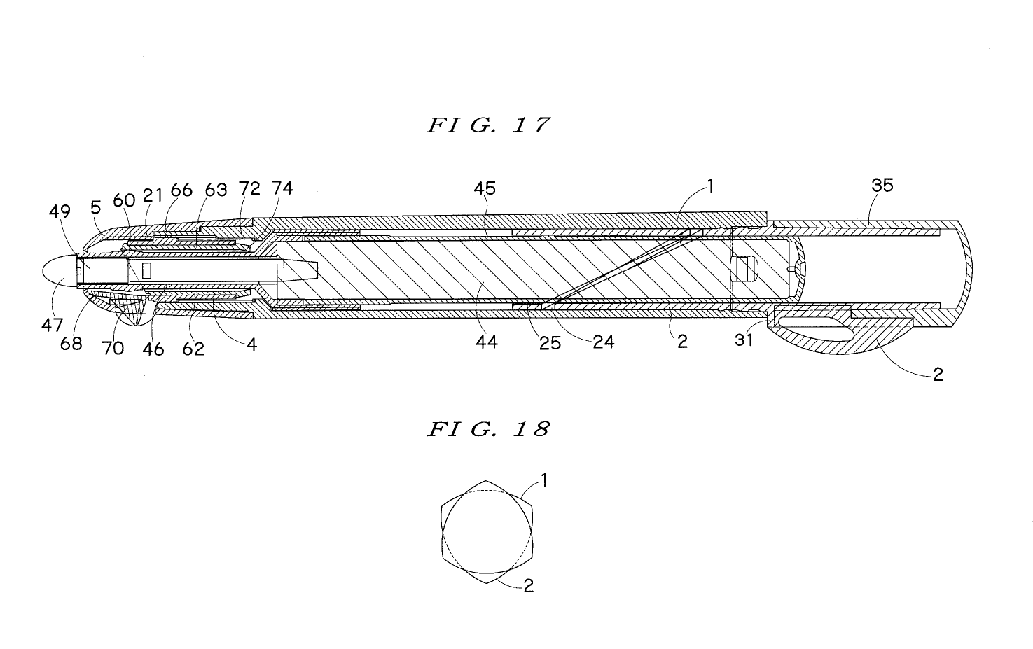

From this state, when the working cam 2 begins to be rotated by the user using the knob piece 33 as a guide, since the cam groove 24 rotates, the refill 3 including the ink reservoir 45, lead tube 46 and tip 49 is guided by the cam groove and moved axially forward via the guide pin 50, and the sealing section 4 is also moved forward by the action of the spring 72 as shown in FIG. 15. When the pressing rib 70 of the sealing section 4 abuts on the pawl 20 of the tapered member 5, the lid 68 is opened while the pressing rib 70 is allowed to enter the escape hole 18 as shown in FIG. 16. At this moment, the guide projection 66 of the holder 62 abuts on the end face of the plane portion 21 of the tapered member 5, whereby the advancing movement of the seal section 4 is stopped. As the working cam 2 continues to rotate, the refill 3 is moved further forward until the writing front end 47 of the refill protrudes from the opening 17 of the tapered member 5 as shown in FIG. 17 and the guide pin 50 has moved to the front end side along the cam groove 24. In this state, the state of the outer configurations of the main body 1 and the working cam 2 is schematically illustrated in FIG. 18 which shows that the outer configurations or profiles thereof are shifted relative to one another. Accordingly, by either viewing or touching the outer configurations of the main body 1 and the working cam 2, it can be easily understood that the sealing section 4 is released and the writing front end 47 protrudes.

From the state shown in FIG. 17, when the working cam 2 is rotated in the reverse direction, the refill 3 retracts, and when the elastic pawls 64 of the holder 62 engage with the side face of the sealing projection portion 60, the sealing section 4 is moved rearward together with the refill 3. As the sealing section 4 moves rearward, the pressing rib 70 moves slidingly on the inner face of the tapered member 5, and the lid 68 pivots and starts to close the opening of the cylindrical seal (see FIGS. 16 and 15). At the end of the rearward movement of the sealing section 4, the writing front end 47 of the refill 3 is completely housed in the sealing section 4, the lid 68 closes the opening of the cylindrical seal 63, and the sealing projection portion 60 and the inner sealing projection 74 are pressed closely together for completion of sealing. This state is the state shown in FIG. 1A in which the rotation of the working cam 2 is stopped. In this state, the outer configurations or profiles of the main body 1 and the working cam 2 coincide with each other as shown in FIG. 14. Therefore by either viewing or touching the outer configurations of the main body 1 and the working cam 2, it can be easily understood that the writing front end 47 of the refill 3 is completely housed in the sealing section 4 and securely sealed. Conversely, when the outer configurations of the main body 1 and the working cam 2 do not coincide with each other, it is clearly understood from either viewing the outer appearance or touching the non-coincident outer configurations that the housing of the writing front end 47 and the sealing are incomplete, and in such case, the working cam needs to be turned further until it stops in order to fully retract and seal the writing front end 47.

In the above examples, the cross sections of the main body 1 and the working cam 2 are formed in a generally regular triangle shape. However, as mentioned above, other cross-section shapes can be used provided that, when the working cam is located at the start position of rotation, the outer configurations of the main body and the working cam coincide with each other, and when the working cam rotates, the outer configurations are shifted, and rotation of the working cam can be visually and tactilely discerned. Accordingly, so long as rotation of the working cam can be discerned, the main body and the working cam may have a cross section other than the generally regular triangle shape, for example, a polygonal shape or an oval shape, or any other shape different from a circle.

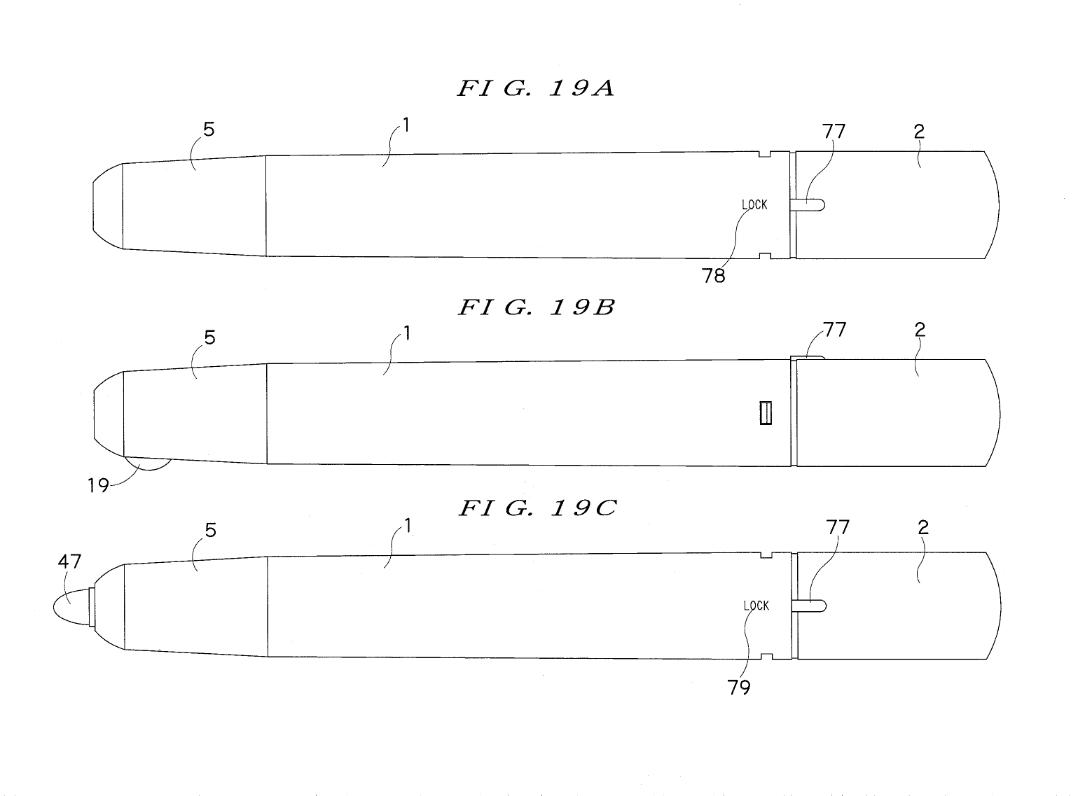

In addition, the present invention can be embodied in a writing instrument having a main body and a working cam of circular cross section. For example, as shown in FIGS. 19A-19C, at the rear end portion of the main body 1 and the working cam 2, an indication mark 77 may be disposed in the form of a rib-like projection or a recess in such a fashion that the positions of the indication mark are shifted between the start position of rotation and the end position of rotation. Further, indication marks 78, 79 such as “LOCK” or “UNLOCK” may be provided by printing, carving, etc. Since the start position of rotation and the end position of rotation can be easily discerned by the positions of these indication marks, the outer configurations of the main body and the working cam may be formed in a circle in cross section.

It will be appreciated by those skilled in the art that obvious changes and modifications can be made to the embodiments and examples described in the foregoing description without departing from the broad inventive concept thereof. It is understood, therefore, that this disclosure is not limited to the particular embodiments and examples disclosed, but is intended to cover all obvious changes and modifications thereof which are within the scope and the spirit of the disclosure as defined by the appended claims.

What is claimed is:

1. A writing instrument, comprising:
a main body;
a working cam rotatably connected to a rear portion of the main body to undergo rotation within a predetermined range and forming part of a screw-shaped cam groove;
a refill inserted in a non-rotatable fashion into the main body and having a guide pin slidably engageable with the cam groove to advance or retract the refill in the axial direction of the main body when the working cam rotates;
a sealing section that seals the front end of the refill when the refill retracts and the front end of the refill is housed in the main body and that releases the sealing to let the front end of the refill protrude when the refill advances; and
a regulating member that regulates the rotation of the working cam so that the working cam rotates between one end position at which rotation starts and the refill is fully retracted and another end position at which the rotation ends and the front end of the refill protrudes from the main body,
wherein the cross section of the main body and the cross section of the working cam have a shape different from a circle so that when the working cam is located at the position at which the rotation starts, the outer configurations of the main body and the working cam coincide with each other, and when the working cam rotates, the outer configurations are shifted and do not coincide with each other, whereby the rotation of the working cam can be discerned by the coincidence or non-coincidence of the outer configurations.

2. The writing instrument according to claim 1, wherein the outer configurations of the main body and the working cam have a generally regular triangle shape in cross section.

3. The writing instrument according to claim 1, wherein the regulating member comprises a control rib extending axially in the main body, and a cutaway portion of the working cam, wherein the cutaway portion is configured so that when the working cam is located at the position at which the rotation starts, one end of the cutaway portion abuts on the control rib, and when the working cam is located at the position to which it rotates 180 degrees from the position of the start of rotation and at which the rotation ends, another end of the cutaway portion abuts on the control rib.

4. The writing instrument according to claim 1, further comprising an internal cam rotatably inserted into the main body, wherein the cam groove is formed between a rear end of the internal cam and a front end of the working cam.

5. The writing instrument according to claim 1, wherein the sealing section comprises a holder surrounding the front end of the refill and a cylindrical seal inserted into the holder, wherein the holder has a lid which opens an opening of the cylindrical seal when the refill advances and closes the opening of the cylindrical seal when the refill retracts.

6. The writing instrument according to claim 5, wherein the holder has an elastic pawl at its rear end, the pawl being in sliding contact with the outer face of the refill so that when the refill retracts, the elastic pawl engages with the refill and moves the holder rearward together with the refill.

7. The writing instrument according to claim 1, wherein the guide pin of the refill is positioned at the rear end side of the cam groove of the working cam when the front end of the refill is housed in the sealing section and sealed, and positioned at the front end side of the cam groove when the front end of the refill protrudes from the sealing section.

8. A writing instrument, comprising:
a main body;
a working cam rotatably connected to a rear portion of the main body to undergo rotation within a predetermined range and forming part of a screw-shaped cam groove;
a refill inserted in a non-rotatable fashion into the main body and having a guide pin slidably engageable with the cam groove to advance or retract the refill in the axial direction of the main body when the working cam rotates;
a sealing section that seals the front end of the refill when the refill retracts and the front end of the refill is housed in the main body and that releases the sealing to let the front end of the refill protrude when the refill advances; and
a regulating member that regulates the rotation of the working cam so that the working cam rotates between one end position at which rotation starts and the refill is fully retracted and another end position at which the rotation ends and the front end of the refill protrudes from the main body,
wherein an indication mark is positioned on each of the main body and the working cam such that the positions of the indication marks are shifted relative to one another from the start position of rotation to the end position of rotation of the working cam, whereby the rotation of the working cam can be discerned by the shift in positions of the indication marks.

9. The writing instrument according to claim 8, wherein the outer configurations of the main body and the working cam have a circular cross section.

10. The writing instrument according to claim 8, wherein the regulating member comprises a control rib extending axially in the main body, and a cutaway portion of the working cam, wherein the cutaway portion is configured so that when the working cam is located at the position at which the rotation starts, one end of the cutaway portion abuts on the control rib, and when the working cam is located at the position to which it rotates 180 degrees from the position of the start of rotation and at which the rotation ends, another end of the cutaway portion abuts on the control rib.

11. The writing instrument according to claim 8, further comprising an internal cam rotatably inserted into the main body, wherein the cam groove is formed between a rear end of the internal cam and a front end of the working cam.

12. The writing instrument according to claim 8, wherein the sealing section comprises a holder surrounding the front end of the refill and a cylindrical seal inserted into the holder, wherein the holder has a lid which opens an opening of the cylindrical seal when the refill advances and closes the opening of the cylindrical seal when the refill retracts.

13. The writing instrument according to claim 12, wherein the holder has an elastic pawl at its rear end, the pawl being in sliding contact with the outer face of the refill so that when the refill retracts, the elastic pawl engages with the refill and moves the holder rearward together with the refill.

14. The writing instrument according to claim 8, wherein the guide pin of the refill is positioned at the rear end side of the cam groove of the working cam when the front end of the refill is housed in the sealing section and sealed, and positioned at the front end side of the cam groove when the front end of the refill protrudes from the sealing section.
